(19) United States
(12) Patent Application Publication
(10) Pub. No.: US 2016/0105091 A1
(43) Pub. Date: Apr. 14, 2016

(54) OIL-SUBMERSIBLE LINEAR MOTOR

(71) Applicants: SHENZHEN HAN'S MOTOR S&T CO., LTD, Shenzhen (CN); HAN'S LASER TECHNOLOGY INDUSTRY GROUP CO., LTD., Shenzhen (CN)

(72) Inventors: Guangneng Wang, Shenzhen (CN); Hui Cao, Shenzhen (CN); Pengyong Zhang, Shenzhen (CN); Yunfeng Gao, Shenzhen (CN)

(21) Appl. No.: 14/894,969

(22) PCT Filed: Dec. 26, 2013
(86) PCT No.: PCT/CN2013/090533

§ 371 Date: Nov. 30, 2015

(51) Int. Cl. H02K 41/03

(52) U.S. Cl. CPC H02K 41/031

(57) ABSTRACT

A submersible linear motor (100) comprising a stator (10) and a mover (20) moving in a linear motion arranged within the stator (10). The stator comprising a stator inner pipe (14), a stator outer pipe (13), and a plurality of windings (11) disposed between the stator inner pipe and outer pipe. The mover comprises a mover inner pipe (21), a plurality of permanent magnets (23), a plurality of magnetic rings (24), and a plurality of wearing rings (25). The plurality of permanent magnets and magnetic rings being sleeved onto the mover inner pipe. Each magnetic ring arranged between two adjacent permanent magnets. The plurality of permanent magnets being arranged between every two wearing rings. The plurality of wearing rings forming a friction pair with the stator inner tube, ensuring the smooth operation of the motor and reducing vibration.

### FIELD OF THE INVENTION

The present disclosure relates to motors, and more particularly, relates to a high effective submersible liner motor.

### BACKGROUND OF THE INVENTION

The conventional oil pump machine mainly adopts a beam-pumping unit (pumpjack) to pump oil. In the process of pumping oil, the pumpjack, which serves as a mechanical power apparatus, is connected to a piston of an oil pump located thousands of meters underground via an oil pump rod. The oil pump rod reciprocally drives the piston of the oil pump to lift oil to the ground. The oil pump machine mainly has disadvantages as follows: high energy consumption, low pumping efficiency, eccentric wear between the oil pump rod and an oil discharging tube, it requires stopping the machine for adjusting the parameters, and the adjusting range of the parameter is limited.

Submersible pump driven by linear motor is capable of transferring electric energy into mechanical energy of straight reciprocal motion, not only simplifying the mechanical transmission process, but also effectively improving the efficiency. The pumping parameter can be continuously adjusted, thus providing conditions for realizing an automatic control and meeting a requirement of oil pump technology, it is a promising new type of pumping machine. However, there is room for improving a reliability of the linear motor of the conventional pumping machine.

### SUMMARY OF THE INVENTION

Therefore, it is necessary to provide a submersible linear motor having a high reliability.

A submersible linear motor includes a stator and a mover moving linearly in the stator. The stator includes a stator inner tube, a stator outer tube, and a plurality of windings positioned between the stator inner tube and the stator outer tube. The mover includes a mover inner tube, a plurality of permanent magnets, a plurality of magnetic rings, and a plurality of wearing rings. The plurality of permanent magnets is sleeved on the mover inner tube, the plurality of magnetic rings is sleeved on the mover inner tube, and each magnetic ring is disposed between two adjacent permanent magnets. The plurality of wearing rings is sleeved on the mover inner tube. Several permanent magnets are positioned between every two wearing rings. The plurality of wearing rings and the stator inner tube form a friction pair.

According to one embodiment, the winding is a circular wire pie formed by twining a conductive wire and encapsulating the conductive wire with epoxy resin. Two adjacent windings are provided with a silicon steel plate assembly therebetween. The windings are insulated from the silicon steel plate assembly.

According to one embodiment, the stator further comprises a cable connected to the windings. The stator is connected to a control system located on a ground via the cable.

According to one embodiment, the stator further comprises a motor upper coupler and a motor lower coupler positioned on opposite ends of the stator outer tube. Glue is filled between the motor upper coupler and the motor lower coupler, and between the stator inner tube and the stator outer tube, such that the stator is solidified as a whole.

According to one embodiment, a magnetizing direction of each permanent magnet is axial, and the magnetizing directions of two adjacent permanent magnets are opposite.

According to one embodiment, the plurality of permanent magnets comprise a plurality of first magnets magnetized along an axial direction and a plurality of second magnets magnetized along a radial direction. The first magnets and the second magnets are alternatively arranged along an axial direction of the mover inner tube. Magnetizing directions of adjacent two first permanent magnets are opposite and magnetizing directions of adjacent two second permanent magnets are opposite.

According to one embodiment, the mover further comprises a plurality of mover outer tubes. Each mover outer tube is sleeved on the permanent magnets and the magnetic rings and is positioned between adjacent two wearing rings. An outer diameter of the mover outer tube is less than that of the wearing ring.

According to one embodiment, the mover further comprises two locknuts positioned on opposite ends of the mover outer tube and configured to compress the permanent magnets and the magnetic rings.

According to one embodiment, the mover inner tube is hollow, the mover and the stator are filled with lubricating oil therebetween, the lubricating oil can flow inside the mover inner tube.

According to one embodiment, the permanent magnet is made of neodymium iron boron alloy.

The wearing ring of the above submersible linear motor and the stator inner tube rub against each other during the operation of the motor, which can ensure a smooth travelling of the motor without vibration. Such friction pair has a high reliability and a long service life.

### BRIEF DESCRIPTION OF THE DRAWINGS

These and other features of the present invention will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIG. 1 is a cross-sectional view of a submersible linear motor oil pumping system, according to one embodiment;

FIG. 2a is an enlarged view of the submersible linear motor of FIG. 1;

FIG. 2b is a partial, enlarged view of a submersible linear motor, according to another embodiment;

FIG. 3a is an enlarged, cross-sectional view of an oil pump of FIG. 1 in one state;

FIG. 3b is an enlarged, cross-sectional view of the oil pump of FIG. 1 in another state; and

FIG. 4 is an enlarged view of a portion of a sealing device of FIG. 1.

### DETAILED DESCRIPTION OF THE EMBODIMENTS

Embodiments of the invention are described more fully hereinafter with reference to the accompanying drawings. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art. Elements that are identified using the same or similar reference characters refer to the same or similar elements.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

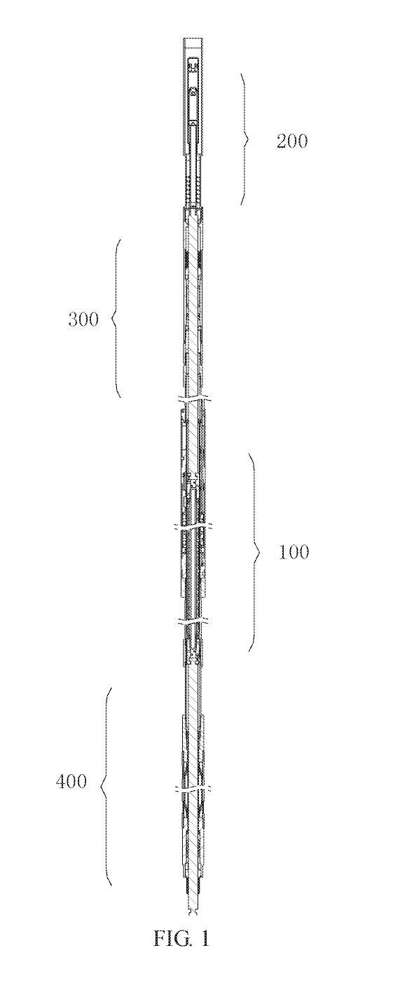

Referring to FIG. 1, a submersible linear motor oil pumping system includes a submersible linear motor 100, an oil pump 200, a sealing device 300, and a balance assembly 400, which are all mounted underground. The oil pump 200 is positioned above the submersible linear motor 100. The balance assembly 400 is positioned below the submersible linear motor 100. The sealing device 300 is positioned between the oil pump 200 and the submersible linear motor 100.

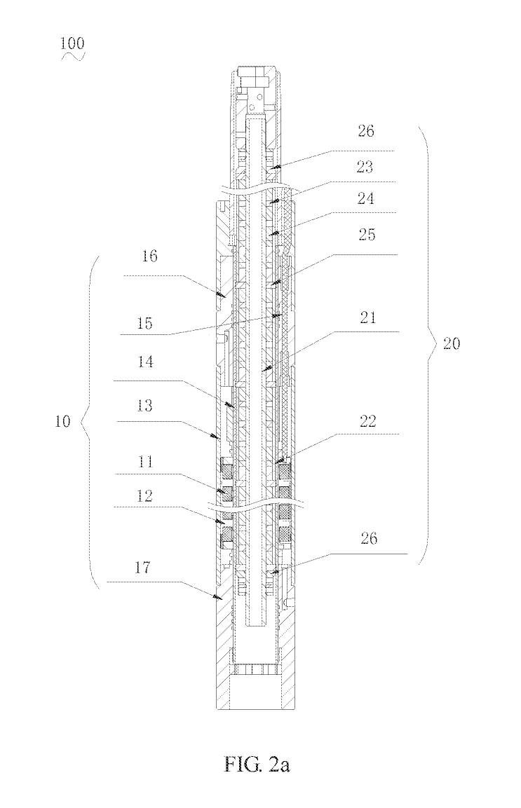

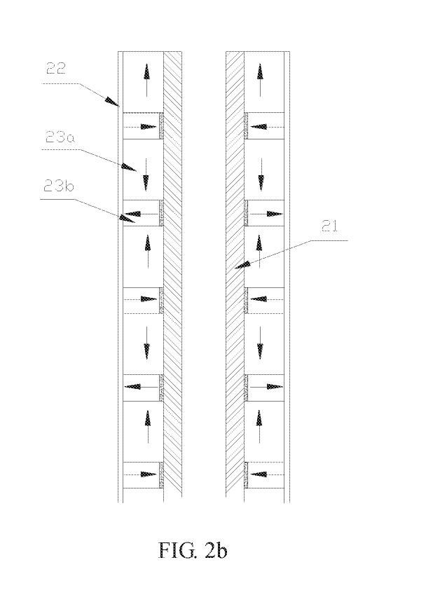

Referring to FIG. 2a, the submersible linear motor 100 is a power source of the whole system, and includes a stator 10 and a mover 20 received in the stator 10 for reciprocating movement. The stator 10 includes a stator inner tube 14, a stator outer tube 13, and a plurality of windings 11 positioned between the stator inner tube 14 and the stator outer tube 13. The stator outer tube 13 is made of metallic material having a high permeability. The rigidity of the stator outer tube 13 should be taken into consideration, thus avoiding a magnetic saturation of the motor, preventing the deformation of the motor, and protecting an internal structure of the motor. The stator inner tube 14 is made of wear-resisting metal which is not conductible for magnetic. The stator inner tube 14 serves as a component directly contacting the mover 20, thus the surface thereof should be smooth and wear-resisting. The stator inner tube 14 can be subjected to a special surface hardening treatment, such as a nitrogen treatment, a chromate treatment, or a spraying welding, to adapt to harsh environments of different oil wells. As formed by connecting three-phase coils, the windings 11 are circular copper (or aluminum) wire pies formed by twining a conductive wire and encapsulated with epoxy resin. The windings 11 are arranged along an axial direction of the stator inner tube 14. A silicon steel plate assembly 12 is provided between two adjacent windings 11. The silicon steel plate assembly 12 consists of a plurality of silicon steel plates laminated together, thus it has a better magnetic property and less core loss. An insulating layer is provided between the windings 11 and the silicon steel plate assembly 12. The insulating layer is made of insulating material having a better heat-conducting property so as to ensure a better heat dissipation performance and insulation and improve a reliability of the motor. The stator 10 further includes a cable 15 connected to the windings 11. The cable 15 can be an armor flat cable special for oil fields. An end of the cable 15 extends to connect with a control system (not shown) over-ground. The cable 15 is sealed by filler squeezing in the wire outlet, which can be subject to 30 MPa high pressure environments. The stator 10 further includes a motor upper coupler 16 and a motor lower coupler 17 on opposite ends of the stator outer tube 13. The submersible linear motor 100 is connected to the sealing device 300 via the motor upper coupler 16, and connected to the balance assembly 400 via the motor lower coupler 17. The motor upper coupler 16, the motor lower coupler 17, the stator inner tube 14, and the stator outer tube 13 cooperatively form an airtight cavity to protect the windings 11 and the silicon steel plate assembly 12. Epoxy resin glue is injected into the airtight cavity to fully fill the clearances inside the stator, and then the whole stator is solidified to form an entire body, which greatly enhances the rigidity and reliability.

The mover 20 includes a mover inner tube 21, a mover outer tube 22, a plurality of permanent magnets 23, a plurality of magnetic rings 24, a plurality of wearing rings 25, and two locknuts 26. The mover inner tube 21 has a hollow tubular structure. The material of the permanent magnets 23 is preferably made of neodymium iron boron alloy with a high performance and a high coercive force. The permanent magnet 23 is substantially in an annular shape. The plurality of permanent magnets 23 is sleeved on the mover inner tube 21. The magnetizing direction of each permanent magnet 23 is arranged along an axial direction. The magnetizing directions of two adjacent permanent magnets 23 are opposite. The magnetic ring 24 is also substantially in an annular shape and has a same diameter as that of the permanent magnet 23. The plurality of magnetic rings 24 is sleeved on the mover inner tube 21, and each magnetic ring 24 is disposed between two adjacent permanent magnets 23. The magnetic ring 24 is made of metallic material having a better magnetic conductivity. The wearing ring 25 has an annular shape. The plurality of wearing rings 25 is sleeved on the mover inner tube 21. The plurality of permanent magnets 23 are provided between every two wearing rings 25. In the illustrated embodiment, every five permanent magnets 23 are arranged between two wearing rings 25. The outer diameter of the wearing ring 25 is slightly greater than that of the magnetic ring 24, thus the surface of the wearing ring 25 protrudes out of the surface of magnetic ring 24. The wearing ring 25 is made of hard alloy, such as Stellite, which has a high hardness and a better magnetic performance. The wearing ring 25 and the stator inner tube 14 rub against each other during the operation of the motor, which can ensure a smooth travelling of the motor without vibration, such friction pair has a high reliability and a long service life. Further, the mover outer tube 22 is sleeved on the permanent magnets 23 and the magnetic rings 24, each mover outer tube 22 is positioned between two wearing rings 25. The mover outer tube 22 has an outer diameter slightly less than the outer diameter of the wearing ring 25, such that the mover outer tube 22 will not rub against the stator inner tube 14. The mover outer tube 22 is made of non-magnetic metallic material. As the permanent magnet has a low corrosion resistance and is brittle, the mover outer tube 22 can effectively protect the permanent magnet 23 from corrosion and impact. The locknuts 26 are mounted on opposite ends of the mover outer tube 22 to compress the permanent magnet 23 and the magnetic ring 24 and avoid them from loosing.

During operation, the parameter can be configured by the numerical control apparatus over-ground according to an actual requirement, and the power is supplied according to specific program, thus allowing the stator 10 to generate a variable magnetic field. The magnetic field of the stator 10 and the magnetic field of the mover 20 cooperatively generate an electromagnetic actuation force, thereby driving the mover 20 to move up and down. Preferably, opposite ends of the motor are sealed, by which an airtight cavity is formed along with the mover 20 and the stator 10. The chamber is filled with lubricating oil. In the reciprocating movement of the motor, since the mover inner tube 20 has a hollow structure, the lubricating oil can flow inside the mover inner tube 21 rapidly, i.e. moving from an end of the mover 20 to an opposite end of the mover 20, forming a loop, thereby reducing a resistance.

Referring to FIG. 2b, in another embodiment, the permanent magnets 23 include a first magnet 23a magnetized along an axial direction and a second magnet 23b magnetized along a radial direction. Magnetized along a radial direction means that the magnetizing field radiates from a center toward a periphery. The first magnet 23a and the second magnet 23b are alternatively arranged along an axial direction of the mover 20, i.e. along the axial direction, there is one first magnet 23a, one second magnet 23b, one first magnet 23a, one first magnet 23b alternatively arranged like these. Surfaces of the first magnet 23a and the second magnet 23b are subjected to an anti-corrosion treatment, thereby enhancing an anti-corrosion performance of the first magnet 23a and the second magnet 23b.

The magnetizing directions of adjacent two first magnets 23a are opposite. The magnetizing directions of adjacent two second magnets 23b are opposite. In other words, among the two first magnets 23a which are respectively positioned above and below the second magnet 23b, one of the two first magnets 23a has a magnetizing direction pointing upward along the axial direction, the other one of the two first magnets 23a has a magnetizing direction pointing downward along the axial direction. Among the two second magnets 23b, which are respectively positioned above and below the first magnet 23a, one of the two second magnets 23b has a magnetizing direction pointing outward along the radial direction, the other one of the two second magnets 23b has a magnetizing direction pointing inward along the radial direction.

By such above arrangement of the first magnets 23a and the second magnets 23b, an air-gap magnetic field can be effectively enhanced, thus increasing a pushing force of the cylindrical submersible linear motor.

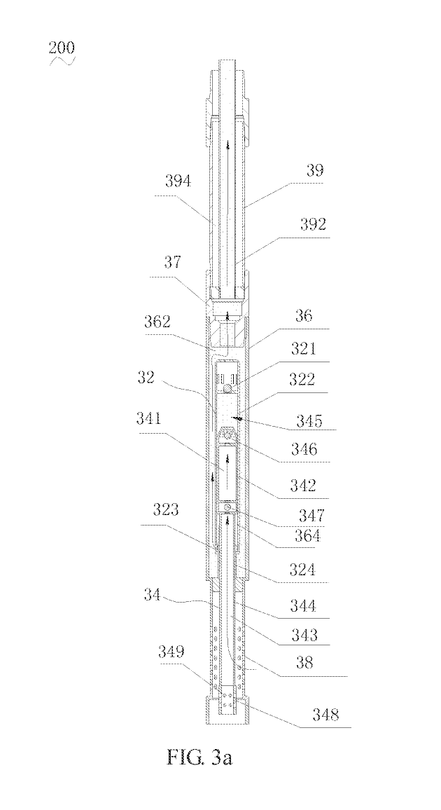

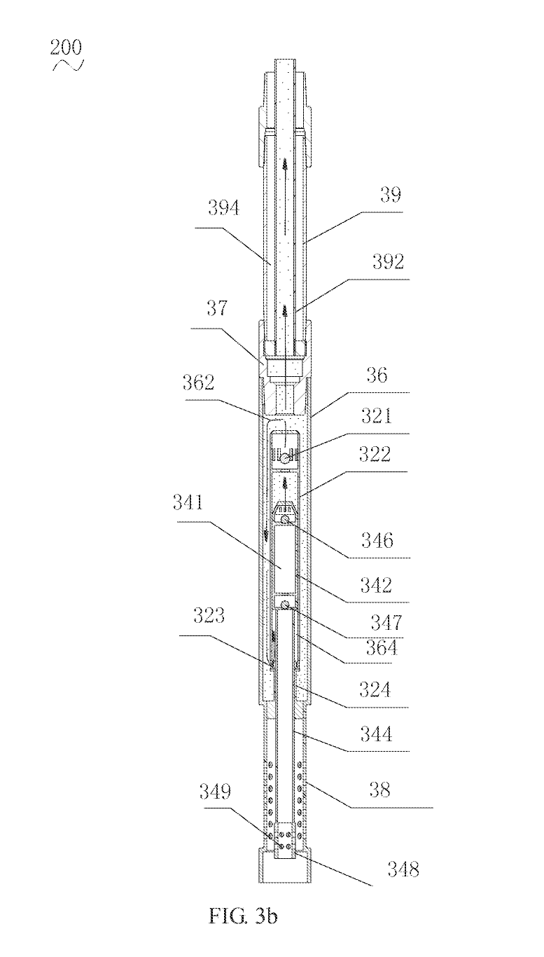

Referring to FIG. 3a, the oil pump 200 is a bi-directional piston pump and includes a barrel 32, a piston 34, an outer sleeve 36, an oil feeding sieve tube 38, and an oil discharging tube 39. The outer sleeve 36 is sleeved on the barrel 32, such that a reflux chamber 362 is formed between the outer sleeve 36 and the barrel 32. The piston 34 is movably positioned in the barrel 32. The inner sidewall of the barrel 32 and the outer sidewall of the piston 34 are required to be subjected to a surface hardening treatment, such as a chromate treatment. The oil feeding sieve tube 38 is fixed to a lower end of the outer sleeve 36, configured to filtrate the sediment in the well liquid.

The barrel 32 includes an upper barrel 322 and a lower barrel 324 fixed to the upper barrel 322. The upper barrel 322 has a diameter greater than that of the lower barrel 324. The upper barrel 322 is provided with a fixed valve 321 at a top end thereof. Well liquid can flow into the first reflux chamber 362 via the fixed valve 321. The upper barrel 322 further defines a reflux hole 323 at a bottom end thereof.

The piston 34 includes an upper piston 342 and a lower piston 344 fixed to the upper piston 342, the upper piston 342 can move up and down in the upper barrel 322 accordingly. The upper piston 342 defines an oil pumping chamber 341. An oil discharging chamber 345 is formed between a top of the upper piston 342 and the upper barrel 322. The upper piston 342 is further provided with a movable valve 346 at the top end thereof. The well liquid can enter the oil discharging chamber 345 from the oil pumping chamber 341 via the movable valve 346. The lower piston 344 can move up and down in the lower barrel 324 accordingly. The lower piston 344 defines an oil suction chamber 343 therein. A one-way valve 347 is provided between the lower piston 344 and the upper piston 342. The well liquid can enter the oil pumping chamber 341 from the oil suction chamber 341 via the one-way valve 347. The lower piston 344 has a less diameter than that of the upper barrel 322, such that a second reflux chamber 364 is formed between the lower piston 344 and the upper barrel 322. The first reflux chamber 362 is in fluid communication with the second reflux chamber 364 via the reflux hole 323. The lower piston 344 is further provided with a coupler 348 at a terminal end thereof. The piston 34 is connected to the mover 20 of the submersible linear motor 100 via the coupler 348. The coupler 348 defines a plurality of oil inlet holes 349. The well liquid can enter the oil suction chamber 343 from the oil feeding sieve tube 38 via the oil inlet holes 349.

An upper end of the outer sleeve 36 is connected to the oil discharging tube 39 via a coupler 37. The oil discharging tube 39 is provided with a desilting pipe 392 therein, which has a diameter than that of the oil discharging tube 39. An annular space 394 for depositing sand is formed between the oil discharging tube 39 and the desilting pipe 392, which is conducive to the wear-protection of the pump and the motor.

The working operation of the oil pump 200 will be fully described hereinafter with reference to FIG. 3a and FIG. 3b.

Referring to FIG. 3a, when the piston 34 moves downward, the fixed valve 321 is closed, the movable valve 346 and the one-way valve 347 are opened. The well liquid is filtrated by the oil feeding sieve tube 38 and enters the oil suction chamber 343, and then enters the oil discharging chamber 345 via the oil pumping chamber 341. Meanwhile, the upper piston 342 moves downward and compresses the volume of the second reflux chamber 364, thus the well liquid in the second reflux chamber 364 can enter the first reflux chamber 362 via the reflux hole 323, and enters the oil discharging tube 39 via the coupler 37.

Referring to FIG. 3b, when the piston 34 moves upward, the fixed valve 321 is opened, the movable valve 346 and the one-way valve 347 are closed. Because the upper piston 342 compresses the volume of the oil discharging chamber 345, the well liquid in the oil discharging chamber 345 can enter the first reflux chamber 362 via the fixed valve 321. Some of the well liquid enters the oil discharging tube 39 via the coupler 37, the rest of the well liquid enters the second reflux chamber 364 via the reflux hole 323, which will then enter the oil discharging tube 39 during the next down stroke of the piston 34.

By analyzing the above movements, it can be inferred that during the up stroke and the down stroke of the piston 34, the oil pump 200 discharges the oil all the time, therefore the pump efficiency can be enhanced, an oil output capacity is increased.

It can be understood that, in an alternative embodiment, the lower barrel 324 can have a diameter equal to that of the upper barrel 322. The reflux hole 323 can also be omitted. When the piston 34 moves downward, the well liquid is filtrated and enters the oil suction chamber 343 from the oil feeding sieve tube 38, and then the well liquid enters the oil discharging chamber 345 via the oil pumping chamber 341. When the piston 34 moves upward, the well liquid in the oil discharging chamber 345 enters the first reflux chamber 362 via the fixed valve 321, and then enters the oil discharging tube 39 via the coupler 37. The oil pump 200 is a one-way oil pump according to the embodiment.

The sealing device 300 is positioned between the submersible linear motor 100 and the oil pump 200, which functions to seal the motor, thus preventing the well liquid and sediment from entering into the motor from an upper of the motor, ensuring a reliability of the motor, prolonging a service life of the motor.

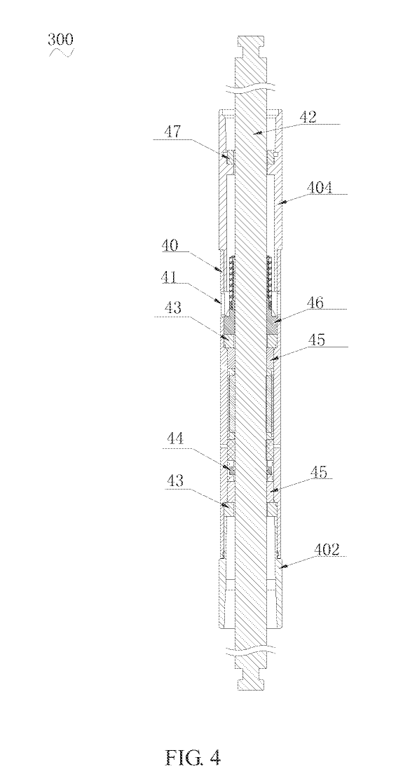

Referring also to FIG. 4, the sealing device 300 includes an external cylinder 40, a connecting rod 42, a sealing assembly 44, and a sand scratcher 46.

The external cylinder 40 is substantially a cylindrical tube and is positioned between the submersible linear motor 100 and the oil pump 200. Specifically, a lower end of the external cylinder 40 is fixedly connected to the motor upper coupler 16 of the submersible linear motor 100 via a sealer lower joint 402. An upper end of the external cylinder 40 is fixedly connected to the oil feeding sieve tube 38 of the oil pump 200 via a sealer upper joint 404. The external cylinder 40 further defines a sewage hole 41. In the illustrated embodiment, the sealer upper joint 404 is further provided with a buffer block 47 therein, configured to buffer an impact coming from the piston 34 of the oil pump 200.

The connecting rod 42 is a solid rod movably extending inside the external cylinder 40. The surface of the connecting rod 42 can be subjected to a hardening treatment, such as chromate treatment. A lower end of the connecting rod 42 is fixed to the mover 20 of the submersible linear motor 100. An upper end of the connecting rod 42 is fixed to the piston 34 of the oil pump 200, therefore the upward and downward movements of the mover 20 can be transmitted to the piston 32.

The sealing assembly 44 is positioned between the connecting rod 42 and an inner sidewall of the external cylinder 40. The sealing assembly 44 functions to block impurities such as the well liquid and sediment from entering into the motor. In the illustrated embodiment, the sealing assembly 44 is a combination of sealing members, such as a U shaped sealing ring and M or V shaped sealing rings. The sealing ring is made of material which is wear-resistant and anti-corrosive, thus ensuring a long enough service life and an air-tightness of the sealing device. An upper end and a lower end of the sealing assembly 44 are provided with locknuts 43 used to fix and compress the sealing assembly 44. The upper end and the lower end of the sealing assembly 44 are provided with a centralizing block 45 to centralize the connecting rod 42, thus ensuring the connecting rod 42 being in the center of the external cylinder 40.

The sand scratcher 46 is positioned between the connecting rod 42 and the inner sidewall of the external cylinder 40 and is located above the sealing assembly 44. An upper end of the sand scratcher 46 is made of elastic material, and it can always be a close contact with the connecting rod 42, by which the impurities such as sediment adhered to the connecting rod 42 can be scraped and discharged out of the sealing device 300 via the sewage hole 41 on the external cylinder 40.

The balance assembly 400 is positioned on the lower end of the submersible linear motor 100, which functions to balance an internal pressure and an external pressure of the motor, meanwhile it can decrease a probability that the impurities enter into the motor, thereby improving a sealing effect, a reliability and a service life of the whole system. The interior of the balance assembly 400 and the motor are filled with the same lubricate oil and is in fluid communication with the interior of the motor, which can balance the internal pressure and the external pressure of the motor, obtaining an effective sealing effect. The balance assembly 400 has a long tail pipe connected to a bottom of a capsule protector via threads. It is hard for the impurities, such as the sediment, to reach a bottom of the balance assembly due to gravity, thus further reducing the probability that the impurities enter into the motor, improving the sealing effect, and enhancing the reliability and the service life of the whole system.

The above described submersible linear motor oil pumping system has advantages as follows:

(1) The system does not use the oil pump rod of the conventional oil pump system, avoiding the stroke loss due to an extension of the oil pump rod. In addition, it avoids the energy loss due to an eccentric wear between the oil pump rod and the hollow rod, and enhances an efficiency of the system, particularly providing a better solution for the deviated well and the horizontal well.

(2) The oil pump of the system is positioned above the submersible linear motor, such that the motor is immersed in the well liquid all the time, thus facilitating to the heat dissipation of the motor, and is also conducive to reducing the noise of the motor. And the motor running underground can avoid an unexpected workload and a maintenance fee due to man-made damages. In addition, in the conventional system that the current pump is mounted below the motor, the well liquid has to flow through an inner hole of the mover, thus the liquid output amount is limited by an inner diameter of the mover. However, the well liquid in the present embodiment is not required to flow through an inner hole of the mover, thereby the liquid output amount will not be limited.

(3) The motor is provided with the sealing device on the upper end, and a balance assembly is provided on the lower end. Thus, the motor can remain in a full-sealing state, preventing the liquid containing sand, gas, H2S, and CO2 which can damage the motor from entering into the motor, obtaining a high reliability and a long service life, enabling the motor to adapt to the harsh environment underground.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A submersible linear motor, comprising:
a stator comprising a stator inner tube, a stator outer tube, and a plurality of windings positioned between the stator inner tube and the stator outer tube; and
a mover moving reciprocally inside the stator, the mover comprising:
a mover inner tube;
a plurality of permanent magnets sleeved on the mover inner tube;
a plurality of magnetic rings sleeved on the mover inner tube, and each magnetic ring being disposed between two adjacent permanent magnets; and
a plurality of wearing rings sleeved on the mover inner tube, several permanent magnets being positioned between adjacent two wearing rings, wherein the plurality of wearing rings and the stator inner tube form a friction pair.

2. The submersible linear motor according to claim 1, wherein the windings are circular wire pies formed by twining a conductive wire and encapsulating the conductive wire with epoxy resin, a silicon steel plate assembly is provided between two adjacent windings, the windings are insulated from the silicon steel plate assembly.

3. The submersible linear motor according to claim 1, wherein the stator further comprises a cable connected to the windings, the stator is connected to a control system located on a ground via the cable.

4. The submersible linear motor according to claim 1, wherein the stator further comprises a motor upper coupler and a motor lower coupler positioned on opposite ends of the stator outer tube, glue is filled between the motor upper coupler and the motor lower coupler and between the stator inner tube and the stator outer tube, such that the stator is solidified as a whole.

5. The submersible linear motor according to claim 1, wherein a magnetizing direction of each permanent magnet is axial, and the magnetizing directions of two adjacent permanent magnets are opposite.

6. The submersible linear motor according to claim 1, wherein the plurality of permanent magnets comprises a plurality of first magnets magnetized along an axial direction and a plurality of second magnets magnetized along a radial direction, the first magnets and the second magnets are alternatively arranged along an axial direction of the mover inner tube, magnetizing directions of adjacent two first magnets are opposite and magnetizing directions of adjacent two second magnets are opposite.

7. The submersible linear motor according to claim 1, wherein the mover further comprises a plurality of mover outer tubes, each mover outer tube is sleeved on the permanent magnets and the magnetic rings and is positioned between adjacent two wearing rings, an outer diameter of the mover outer tube is less than an outer diameter of the wearing ring.

8. The submersible linear motor according to claim 7, wherein the mover further comprises two locknuts positioned on opposite ends of the mover outer tube and configured to compress the permanent magnets and the magnetic rings.

9. The submersible linear motor according to claim 1, wherein the mover inner tube is hollow, the mover and the stator are filled with lubricating oil therebetween, the lubricating oil can flow inside the mover inner tube.

10. The submersible linear motor according to claim 1, wherein the permanent magnets are made of neodymium iron boron alloy.
